(19) United States
(12) Patent Application Publication
(10) Pub. No.: US 2024/0397506 A1
(43) Pub. Date: Nov. 28, 2024

(54) TRANSMISSION OPPORTUNITY RELAYING IN WIRELESS NETWORKS

(71) Applicant: Samsung Electronics Co., Ltd., Suwon-si (KR)

(72) Inventors: Rubayet Shafin, Frisco, TX (US); Elliot Jen, Taipei (TW); Boon Loong Ng, Plano, TX (US); Yue Qi, Plano, TX (US); Peshal Nayak, Plano, TX (US); Vishnu Vardhan Ratnam, Plano, TX (US)

(21) Appl. No.: 18/660,138

(22) Filed: May 9, 2024

Related U.S. Application Data
(60) Provisional application No. 63/468,411, filed on May 23, 2023.

(51) Int. Cl. H04W 72/1263

(52) U.S. Cl. CPC H04W 72/1263

(57) ABSTRACT

A non-access point (AP) station (STA) device in a wireless network, the non-AP STA device comprising a memory a processor coupled to the memory, the processor configured to: obtain a transmission opportunity (TXOP) for transmission of a frame on a link, allocate a portion of the TXOP to a STA, and transmit a notification to the STA indicating the allocation of the portion of the TXOP to the STA.

### CROSS-REFERENCE TO RELATED APPLICATIONS

This application claims the benefit of priority from U.S. Provisional Application No. 63/468,411, entitled “TXOP Relaying Procedures” filed May 23, 2023, which is incorporated herein by reference in its entirety.

### TECHNICAL FIELD

This disclosure relates generally to a wireless communication system, and more particularly to, for example, but not limited to, transmission opportunity (TXOP) relaying procedures in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a non-access point (AP) station (STA) in a wireless network. The non-AP STA comprises a memory and a processor coupled to the memory. The processor is configured to obtain a transmission opportunity (TXOP) for transmission of a frame on a link. The processor is configured to allocate a portion of the TXOP to a STA. The processor is configured to transmit a notification to the STA indicating allocation of the portion of the TXOP to the STA.

In some embodiments, the notification is a trigger frame.

In some embodiments, the STA is another non-AP STA or an AP.

In some embodiments, the non-AP STA and the STA are connected over a Tunneled Direct Link Setup (TDLS) direct link or a peer-to-peer (P2P) link.

In some embodiments, the processor is further configured to allocate another portion of the TXOP to another STA.

In some embodiments, the STA is a controller of a peer-to-peer (P2P) group.

In some embodiments, the processor is further configured to receive a response to the notification from the STA, receive a frame during the portion of the TXOP from the STA, and transmit an acknowledgement to the STA in response to the frame.

On aspect of the present disclosure provides a first access point (AP) in a wireless network. The first AP comprises a memory and a processor coupled to the memory. The processor configured is to obtain a transmission opportunity (TXOP) for transmission of a frame on a link. The processor is configured to allocate a portion of the TXOP to a second AP. The processor is configured to transmit a notification to the second AP indicating allocation of the portion of the TXOP to the second AP.

In some embodiments, the processor is further configured to allocate another portion of the TXOP to a non-AP station (STA).

In some embodiments, the notification is a trigger frame.

One aspect of the present disclosure provides a first station (STA) in a wireless network. The first STA comprises a memory and a processor coupled to the memory. The processor is configured to receive an allocation of a first portion of a transmission opportunity (TXOP) from a second STA, wherein the TXOP is obtained by the second STA for transmission of a frame on a link. The processor is configured to allocate a second portion of the TXOP to a third STA, wherein the second portion is part or all of the first portion of the TXOP. The processor is configured to transmit a notification to the third STA indicating the allocation of the second portion of the TXOP to the third STA.

In some embodiments, the processor is further configured to transmit frames to a fourth STA that is associated with the first STA through a remaining portion of the TXOP.

In some embodiments, the first STA is an access point (AP) or non-AP STA.

In some embodiments, the second STA is an access point (AP) or a non-AP STA.

In some embodiments, the first STA and the third STA are in a peer-to-peer (P2P) group.

In some embodiments, the first STA is a controller of the P2P group.

In some embodiments, the fourth STA is outside of the P2P group.

In some embodiments, the notification is a trigger frame.

In some embodiments, the processor is further configured to receive a response to the notification from the third STA, receive a frame during the second portion of the TXOP from the third STA, and transmit an acknowledgement to the third STA in response to the frame.

In some embodiments, the first STA and the third STA are connected over a Tunneled Direct Link Setup (TDLS) direct link or a peer-to-peer (P2P) link.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates Mode 1 operation of transmission opportunity (TXOP) sharing in accordance with an embodiment.

FIG. 5 illustrates Mode 2 operation for both UL/DL and P2P communication in accordance with an embodiment.

FIG. 6 illustrates TXOP sharing in accordance with an embodiment.

FIG. 7 illustrates TXOP sharing between non-AP STAs in accordance with an embodiment.

FIG. 8 illustrates a frame exchange sequence for TXOP sharing in accordance with an embodiment.

FIG. 9 illustrates an example of TXOP sharing in accordance with an embodiment.

FIG. 10 illustrates an example of TXOP relaying by an STA in accordance with an embodiment.

FIG. 11 illustrates an example of TXOP sharing between APs in accordance with an embodiment.

FIG. 12 illustrates an example of TXOP relaying in accordance with an embodiment.

FIG. 13 illustrates an example frame exchange sequence for TXOP relaying in accordance with an embodiment.

FIG. 14 illustrates a flowchart of an example process of an AP allocating a portion of its TXOP to another AP in accordance with an embodiment.

FIG. 15 illustrates allocating a portion of an obtained TXOP to a P2P group.

FIG. 16 illustrates allocating a TXOP to a group owner (GO) of a Wi-Fi Direct group in accordance with an embodiment.

FIG. 17 illustrates a flowchart of a process of TXOP sharing to P2P group in accordance with an embodiment.

FIG. 18 illustrates a multiuser request-to-send (Mu-RTS) TXOP sharing (TXS) frame format in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

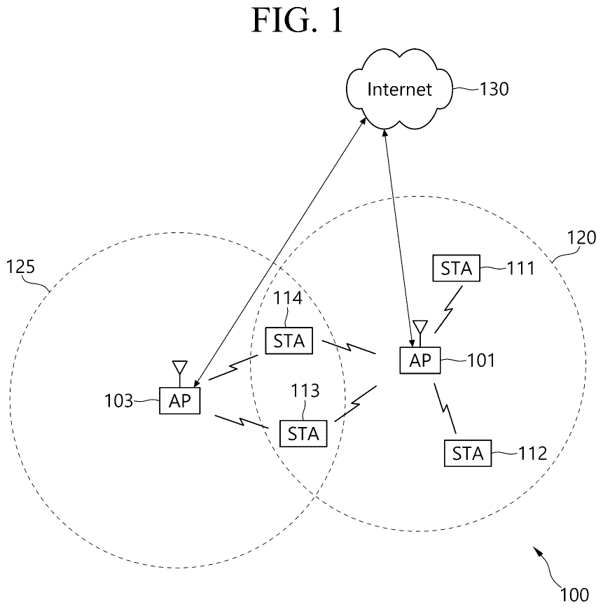

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

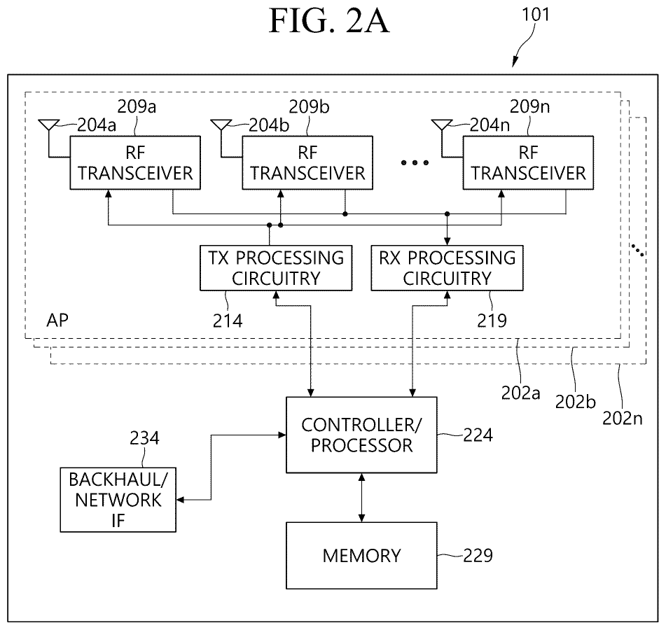

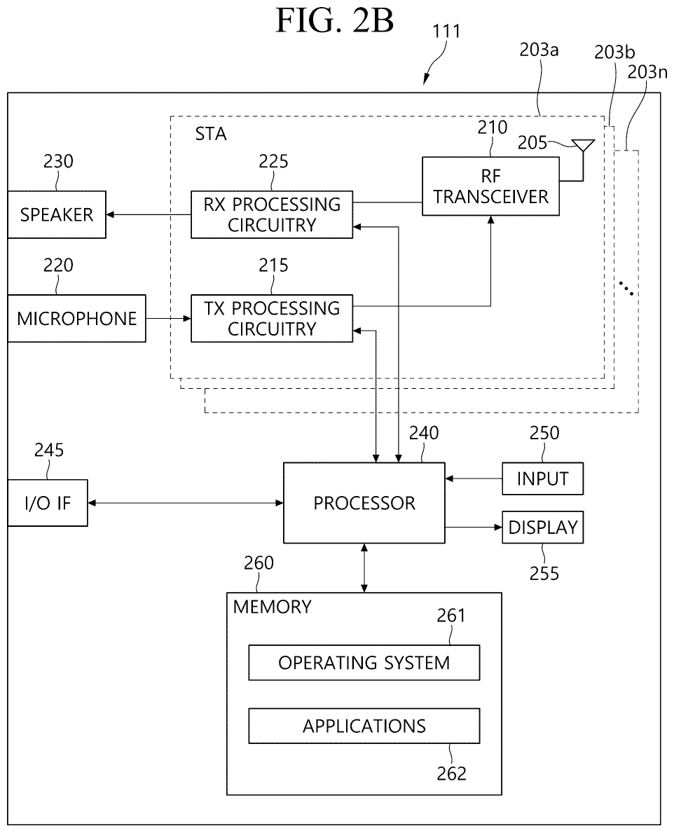

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

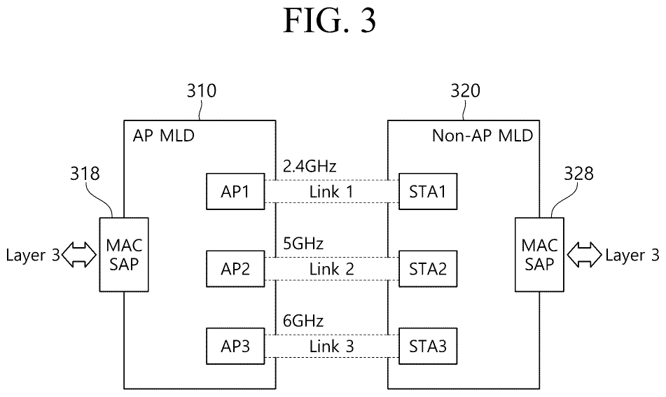

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

Triggered TXOP Sharing (TXS) is a feature in IEEE 802.11be. Using the TXOP sharing procedure, an AP may help an STA to obtain the channel so that the STA can deliver its packets. TXOP sharing procedure may include the following five steps. In step 1, an AP may first obtain the channel, whereby the AP may obtain the TXOP for the wireless medium. In step 2, the AP may decide to allocate a portion of its obtained TXOP to a particular STA, for example STA1, in its BSS. In step 3, the AP may make some indication to STA1 that informs STA1 about the allocated TXOP. In step 4, the STA1 utilizes the allocated TXOP for its uplink or P2P communication. In step 5, the STA1 returns the TXOP to the AP after utilizing its allocated TXOP. The AP may indicate to an STA about the STA's allocated TXOP by using a multi-user request-to-send (MU-RTS) TXS frame, which is a trigger frame introduced in IEEE 802.11be. Currently, one MU-RTS TXS Trigger frame can allocate TXOP to a single STA only, and not more than one STAs.

There are two TXOP sharing modes, which include Mode 1 that is used only for uplink/downlink (UL/DL) communication and Mode 2 which may be used for both UL/DL and peer to peer (P2P) communication.

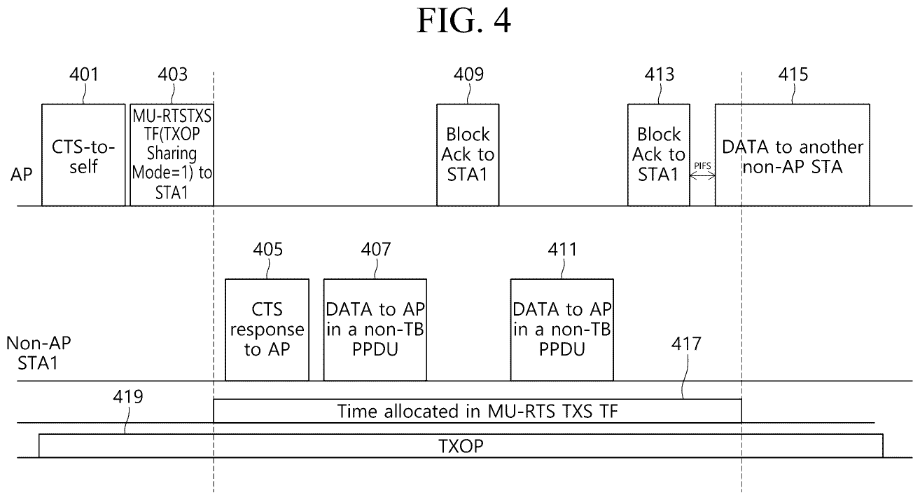

FIG. 4 illustrates Mode 1 operation of TXOP sharing in accordance with an embodiment. In the Mode 1 (UL/DL communication), the AP allocates the TXOP to a STA, illustrated as non-AP STA1, and indicates to the STA1 that the STA1 can use this TXOP 419 only to transmit uplink data packets.

In some embodiments, AP transmits a clear to send (CTS)-to-self 401. A CTS-to-self frame is a CTS frame in which the RA field is equal to the transmitter's MAC address. Then, AP transmits a MU-RTS TXS TF (TXOP Sharing Mode=1) 1403 to STA 1. AP allocates a portion of time, indicated as Time allocated in MU-RTS TXS TF 417, of the TXOP 419 to STA1. Accordingly, during the allocated portion of time 417, STA 1 exchanges frames with AP. For instance, STA1 transmits a CTS 405 response to AP. Subsequently, STA 1 transmits data in a non-Trigger Based Physical Layer Protocol Data Unit (non-TB PPDU) 407 to AP. The AP transmits a Block Ack 409 to STA1. STA1 transmits another data in non-TB PPDU 411 to AP and the AP transmits a Block Ack 413 to STA1. Then, AP transmits data 415 to another non-AP STA.

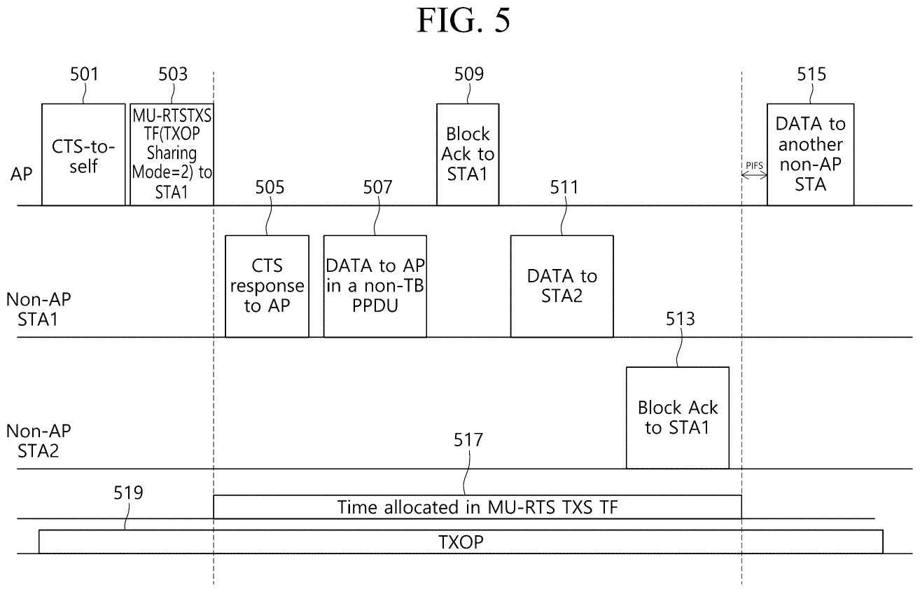

FIG. 5 illustrates Mode 2 operation for both UL/DL and P2P communication in accordance with an embodiment. In Mode 2, the AP allocates the TXOP to a STA and indicates to the STA that the STA can use this TXOP for both uplink communication and P2P communication. As illustrated in FIG. 5, the STA1 uses the TXOP for both uplink communication with the AP and P2P communication with STA2.

In some embodiments, AP transmits a CTS-to-self 501. In some embodiments, a CTS-to-self may allow an AP to obtain channel access protection, which may provide a lower overhead than a full request-to-send (RTS)/CTS exchange. Accordingly, AP transmits a MU-RTS TXS TF (TXOP Sharing Mode=2) 503 to STA 1. During TXOP 519, there is a portion of the TXOP time allocated for STA1, indicated as Time allocated in MU-RTS TXS TF 517. During the allocated time, STA1 transmits a CTS response 505 to the AP. STA1 transmits data in a non-TB PPDU 507 to the AP. The AP transmits a Block Ack 509 to the STA1. Subsequently, STA1 transmits data 511 to STA2. STA2 transmits a Block Ack 513 to STA 1. After the allocated portion in the MU-RTS TXS TF 517, AP transmits data 515 to another non-AP STA.

Accordingly, in the two TXOP sharing modes, only the access point (AP), after winning the contention, can share the won TXOP with a non-AP STA.

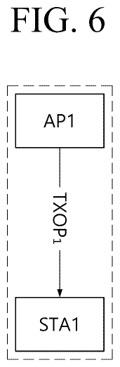

FIG. 6 illustrates an AP sharing an obtained TXOP with a non-AP STA in accordance with an embodiment. In FIG. 6, an AP obtained the TXOP and shares it with a non-AP STA. This scenario where TXOP sharing can be achieved based on the existing standards may be restrictive. Accordingly, many embodiments in this disclosure can improve TXOP sharing by extending the TXOP procedures. In particular, many embodiments provide procedures that include TXOP relaying to extend the TXOP procedures as described herein.

In some embodiments, a first non-AP STA can share its obtained TXOP with a second non-AP STA. Upon obtaining the TXOP, the first STA can allocate a portion of its obtained TXOP to the second non-AP STA.

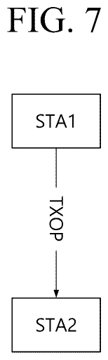

FIG. 7 illustrates an example of TXOP sharing in accordance with an embodiment. In FIG. 7, a first non-AP STA, STA1, wins the channel and obtains the TXOP and allocates a portion of its obtained TXOP to a second non-AP STA, STA2. The STA1 can send a trigger frame to the STA2 indicating the TXOP allocation to the STA2. The trigger frame can be an MU-RTS TXS trigger frame and/or other types of trigger frames. The STA1 and the STA2 may have a Tunneled Direct Link Setup (TDLS), a peer-to-peer (P2P) link set up, or may not have any P2P link set up, among various other types of setups.

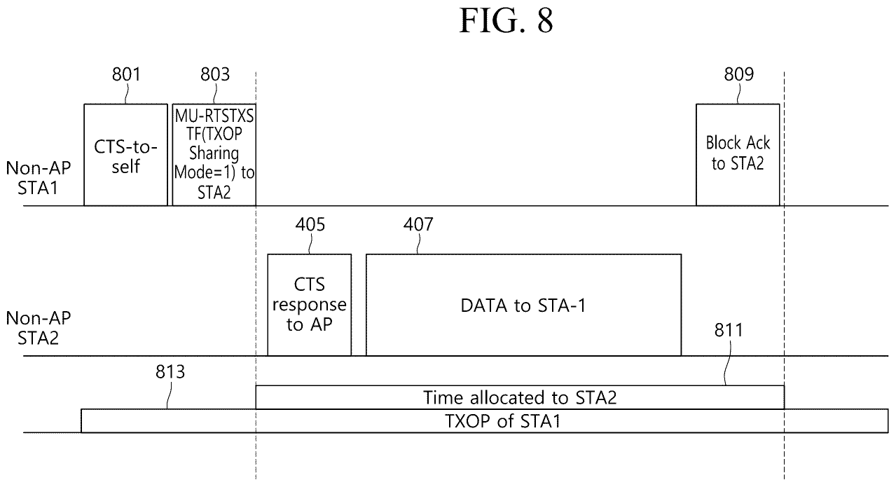

FIG. 8 illustrates an example of a frame exchange sequence for TXOP sharing in accordance with an embodiment. As illustrated, non-AP STA1 (STA1) transmits a CTS-to-self 801. STA1 transmits a MU-RTS TXS TF (TXOP Sharing Mode=1) 803 to non-AP STA2 (STA2). There is a TXOP 813 of STA1, and an allocated portion of the TXOP 813 to STA2, indicated as Time allocated to STA2 811. During the allocated portion 811 of the TXOP 813, STA2 transmits a CTS 805 response to STA1. Subsequently, STA2 transmits data 807 to STA1. STA1 transmits a Block Ack 809 to STA2.

In some embodiments, a non-AP STA can share its obtained TXOP with an AP. Upon obtaining the TXOP, the non-AP STA can allocate a portion of its own TXOP to the AP.

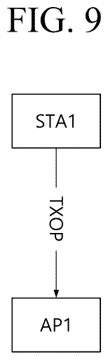

FIG. 9 illustrates an example of an STA sharing an obtained TXOP with an AP in accordance with an embodiment. In FIG. 9, a non-AP STA, STA1, shares a portion of its obtained TXOP with an AP, AP1. The STA1 can send a trigger frame to the AP1 indicating the TXOP allocation to the AP1. The trigger frame can be an MU-RTS TXS trigger frame or other types of trigger frames. The STA1 may or may not be associated with the AP1.

In some embodiments, when a first STA (AP or non-AP STA) receives a TXOP allocation (TXOP1) from a second STA (AP or non-AP STA), the first STA can relay or forward a portion (TXOP2) of the allocation (TXOP1) to a third STA.

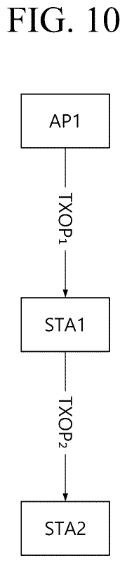

FIG. 10 illustrates an example of TXOP relaying in accordance with an embodiment. In FIG. 10, AP1 wins the channel and obtains the TXOP. AP1 allocates a portion of the TXOP to STA1, which is indicated as TXOP1. Upon receiving the TXOP from AP1, STA further relays a portion of TXOP1, indicated as TXOP2, to STA2.

In some embodiments, a first AP, after obtaining a TXOP, can allocate a portion of its obtained TXOP to a second AP.

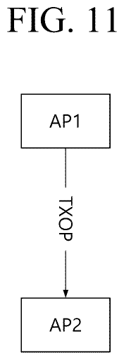

FIG. 11 illustrates an example of TXOP sharing in accordance with an embodiment. In FIG. 11, AP1 obtains a TXOP and then allocates a portion of its obtained TXOP to AP2.

In some embodiments, when a first AP receives a TXOP from a second AP, the first AP can allocate a portion of its received TXOP either to a third AP or to a non-AP STA.

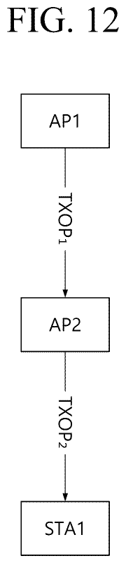

FIG. 12 illustrates another example of TXOP relaying in accordance with an embodiment. In FIG. 12, AP1 obtains a TXOP and allocates a portion (TXOP1) of the obtained TXOP to AP2. AP2 receives a TXOP1 from AP1. Subsequently, AP2 allocates a portion of TXOP1, indicated as TXOP2, to STA1.

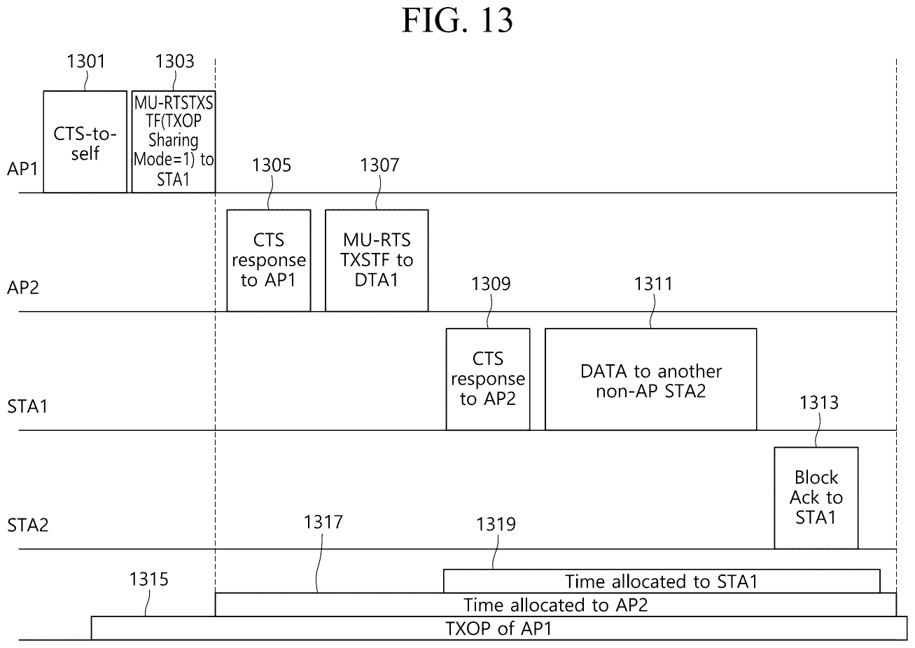

FIG. 13 illustrates an example of a frame exchange sequence of a TXOP relay in accordance with an embodiment. In FIG. 13, AP1 obtains the initial TXOP 1315. AP1 transmits a CTS 1301 to self. AP1 then allocates a portion of its obtained TXOP, illustrated as Time allocated to AP2 1317, to AP2 by sending a trigger frame, illustrated as MU RTS TXS TF 1303, to AP2. AP2 transmits a CTS 1305 response to AP1. AP2 then sends a portion of the TXOP it received from AP1, illustrated as time allocated to STA1 1319, to STA1 by sending a trigger frame, illustrated as MU-RTS TXS TF 1307, to STA1. Upon receiving the TXOP from AP2, STA1 responds by sending CTS 1309, and then uses the TXOP to transmit data to another STA, STA2. For instance, STA1 transmits data 1311 to STA2. STA2 transmits a Block Ack 1313 to STA1.

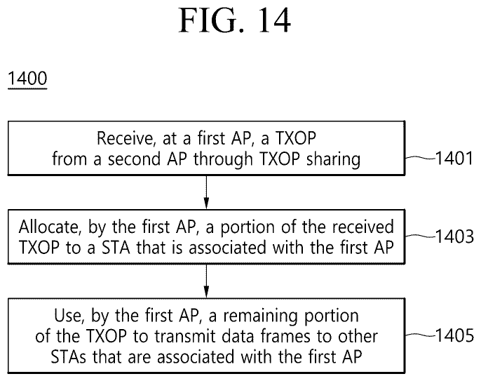

FIG. 14 illustrates a flowchart of a process of an AP allocating a portion of its TXOP to an STA in accordance with an embodiment. In operation 1401 of the process 1400, the first AP receives a TXOP from a second AP through TXOP sharing, whereby the second AP obtains a TXOP and allocates a portion of its obtained TXOP to the first AP. In operation 1403, the first AP allocates a portion of the received TXOP to a STA that is associated with the first AP. In operation 1405, the first AP uses a remaining portion of the TXOP to transmit data frames to other STAs that are associated with the first AP.

In some embodiments, a first STA, upon obtaining a TXOP, can allocate a portion of its obtained TXOP to a group of P2P STAs. The first STA can make such TXOP allocation by transmitting a trigger frame. In the trigger frame, the receiver ID or the destination ID of the trigger frame can be listed as the P2P group ID, such as a Neighbor Awareness Networking (NAN) cluster-ID, among other identifiers. Such a trigger frame can be referred to as a P2P Group TXOP Sharing Trigger frame. The P2P Group TXOP Sharing Trigger frame can be transmitted as a broadcast frame, an individually addressed frame, and/or as a multi-cast frame, among other types of frames. The first STA that allocates the TXOP may also indicate different usage rules for the TXOP. In some embodiments, the usage rules can include, for example, one or more of the following rules, including i) the TXOP can only be used by one STA that receives the TXOP, ii) the TXOP can be used by any STAs that are member of the P2P group, iii) the TXOP cannot be further relayed to a STA that is not a member of the P2P group, iv) the TXOP can be further relayed to a STA that is a member of the indicated P2P group, and v) the entire portion of the TXOP can be used by the STA that receives the TXOP and that is a member of the indicated P2P group.

In some embodiments, a STA that is a member of the indicated P2P group can receive the TXOP to transmit to another STA.

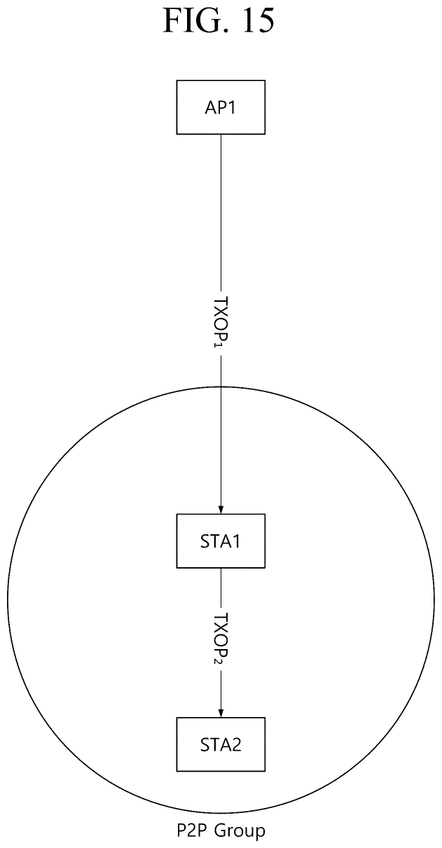

FIG. 15 illustrates an example of allocating a portion of an obtained TXOP in accordance with an embodiment. If FIG. 15, an STA (AP1 in the figure) allocates a TXOP to a P2P group. In particular AP1 allocates a TXOP, TXOP 1, to STA1 in a P2P group. Subsequently, STA1 allocates a portion of the TXOP, indicated as TXOP2, to another STA, STA2, that is a member of the P2P group.

In some embodiments, a first STA that obtains a TXOP can allocate a portion of its obtained TXOP to a group owner (GO) of a P2P group. The first STA can make such TXOP allocation by transmitting a trigger frame to the GO by indicating the GO's AID or MAC address as the receiver address or destination address of the trigger frame. The GO, upon receiving the TXOP, may either use the TXOP to transmit to another STA within the P2P group managed by the GO or relay a portion of the received TXOP to another STA that is a member of the P2P group or that is outside of the P2P group.

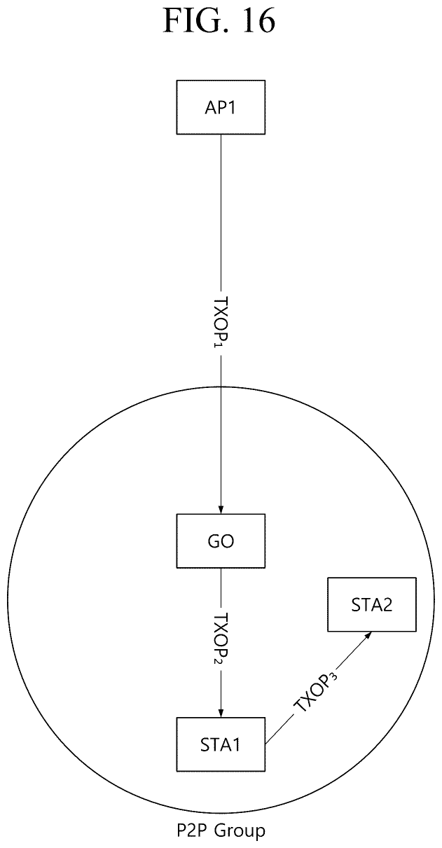

FIG. 16 illustrates allocating a TXOP to a GO of a Wi-Fi Direct group in accordance with an embodiment. In FIG. 16, AP1 allocates its obtained TXOP, indicated as TXOP1, to the GO of a P2P group. The GO further allocates a portion of the TXOP1, indicated as TXOP2, to STA1, where STA1 is a member of the P2P group. STA1 then further allocates a portion of the TXOP2, indicated as TXOP3, to STA2, where STA2 is also a member of the P2P group.

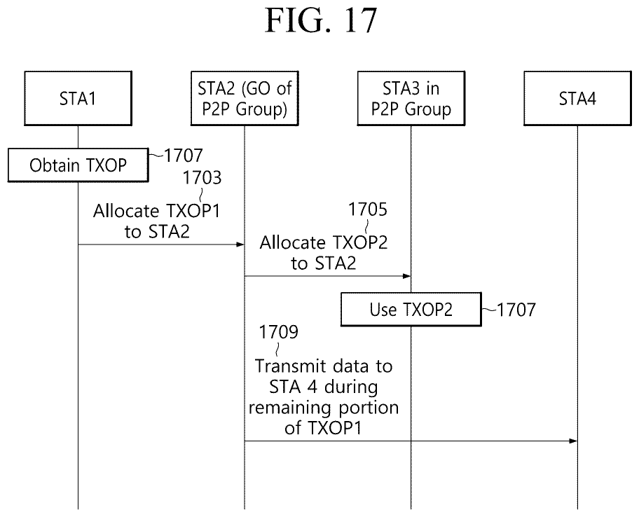

FIG. 17 illustrates an example communication diagram of TXOP sharing in a P2P group in accordance with an embodiment. AT 1701, STA1 obtains a TXOP. At 1703, STA1 allocates TXOP1, which is a portion of the TXOP, to STA2 where STA2 operates as a Group Owner (GO) for a P2P group. At 1705, STA2 allocates a TXOP2, which is a portion of TXOP1, to STA3 which is a member in the P2P group. At 1707, STA3 uses the TXOP2. Subsequently, at 1709, STA2 uses the remaining portion of the TXOP1 to transmit data frames to STA4.

In some embodiments, when a STA allocates TXOP to a GO, it can make an indication in the trigger frame a set of usage rules for how the recipient can utilize the received TXOP. Some example usage rules can include the following rules: i) whether the TXOP can only be used by one the GO or whether the GO can further allocate the TXOP to another STA, ii) if the GO can further allocate a portion of the received TXOP to another STA, iii) whether an STA that a GO can further allocate a portion of a TXOP can be outside of the P2P or has to be a member of the P2P group, iv) whether the GO can use the TXOP to transmit frames to another STA in the P2P group, v) whether the GO can use the TXOP to transmit to an AP, and vi) whether the GO can use the TXOP to some STAs that are not members of the P2P group.

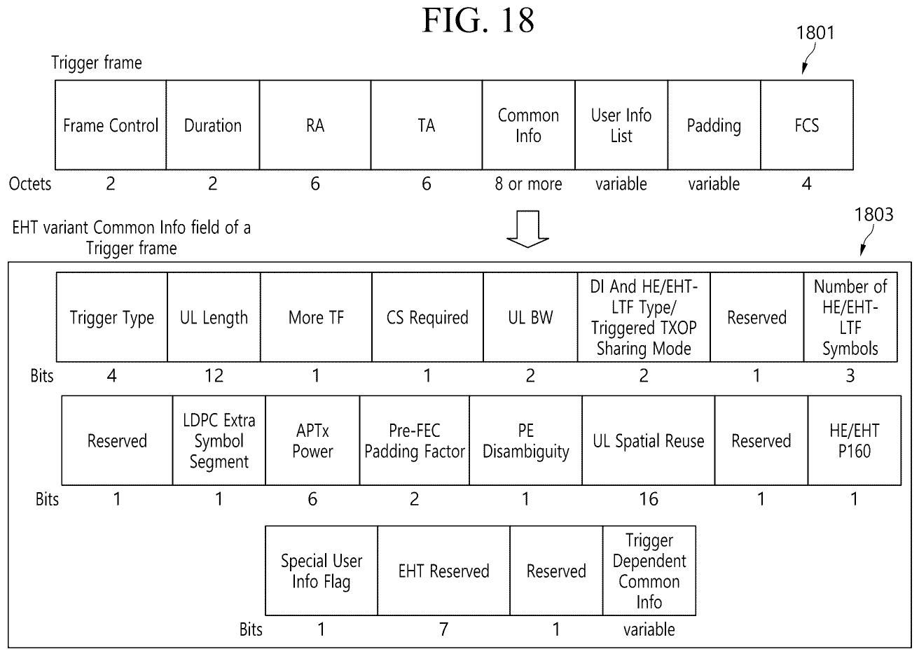

FIG. 18 illustrates an MU-RTS TXS frame in accordance with an embodiment. In particular, FIG. 18 illustrates an MU-RTS TXS trigger frame 1801 and an EHT variant Common Info field 1803 of the trigger frame. The MU-RTS TXS frame can include one or more fields, including, but not limited to, a frame control field, a duration field, a receiver address (RA) field, a transmitter address (TA) field, a Common Info field, a User Info List field, a Padding field, and a frame check sequence (FCS) field.

The Frame control field can include a value to indicate the type of frame. The Duration field may be set to the estimated time, in microseconds, required to transmit the pending frame(s). The Receiver Address (RA) field may include the address of the receiver of frame. The Transmitter Address (TA) field may include the address of the transmitter of the frame. The Common Info Field may indicate the MU-RTS TXS Mode and include one or more subfields, as described below. The User Info List may indicate a value of the bandwidth (BW) associated with the MU-RTS frame (and/or BW associated with the PPDU carrying the MU-RTS frame—for example, but not limited to, 320 MHz, 160+160 MHz, 240 MHz, 160+80 MHZ). The Padding field may be used for additional padding to compensate for different lengths of different MU-RTS frames. The FCS field is a frame check sequence for error-detection.

The EHT variant Common Info field 1803 of the trigger frame 1801 may include a Trigger Type field, a UL length field, a More Trigger Frame (TF) field, a Carrier Sense (CS) required field, an Up Link Bandwidth (UL BW) field, A DI and HE/E HT-LTF Type/Triggered TXOP Sharing Mode field, a Reserved Field, a Number of HE/EHT-LTF Symbols field, a Reserved field, a Low-Density Parity Check (LDPC) Extra Symbol Segment field, a AP transmitter (TX) power field, a Pre-FEC Padding Factor field, a PE Disambiguity field, a UL Spatial Resue field, a Reserved field, an HE/EHT P160 filed, a Special User Info Flag field, a EHT Reserved field, a Reserved field, and a Trigger Dependent Common Info field.

The trigger type field may indicate a MU-RTS trigger frame. The UL Length field may signal a length of the expected response frame. The More TF field may indicate whether or not a subsequent trigger frame is scheduled for transmission. The CS Required field is set to 1 to indicate that the STAs identified in the User Info fields are required to use Energy Detect (ED) to sense the medium and to consider the medium state and the Network Allocation Vector (NAV) in determining whether or not to respond. The UL BW field (Up Link Bandwidth) indicates the bandwidth of the transmission. The GI and HE/EHT LTF Type/Triggered TXOP Sharing Mode field indicates the guard interval and long training field (GI and HE/EHT-LTF) type of the HE or EHT TB PPDU response, and the field may switch meaning between GI and HE/EHT-LTF type and triggered TXOP sharing mode fields based on the trigger type.

The Reserved field is reserved. The Number of HE/EHT LTF Symbols field indicates the number of HE-LTF symbols present in the HE TB PPDU or EHT-LTF symbols present in the EHT TB PPDU, respectively. The Reserved field is reserved. The LDPC Extra Symbol Segment field indicates the status of the LDPC extra symbol segment. The AP TX Power field provides the Tx Power used to transmit the frame. The Pre-FEC Padding Factor field indicates the pre-FEC padding factor. The PE Disambiguity field indicates the PE disambiguity. The UL Spatial Reuse field carries the values to be included in the Spatial Reuse fields in the HE-SIG-A field of the solicited HE TB PPDUs. The Reserved field is reserved. The HE/EHT P160 field may indicate whether the solicited TB PPDU in the primary 160 MHz is an EHT TB PPDU or an HE TB PPDU. The Special User Info Flag field may indicate that a Special User Info field is included in the Trigger frame that contains the EHT variant Common Info field. The EHT Reserved field is reserved. The Reserved field is reserved. The Trigger Dependent Common Info field is optionally present based on the value of the Trigger Type field.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A non-access point (AP) station (STA) in a wireless network, the non-AP STA comprising:
a memory;
a processor coupled to the memory, the processor configured to:
obtain a transmission opportunity (TXOP) for transmission of a frame on a link;
allocate a portion of the TXOP to a STA; and
transmit a notification to the STA indicating allocation of the portion of the TXOP to the STA.

2. The non-AP STA of claim 1, wherein the notification is a trigger frame.

3. The non-AP STA of claim 1, wherein the STA is another non-AP STA or an AP.

4. The non-AP STA of claim 1, wherein the non-AP STA and the STA are connected over a Tunneled Direct Link Setup (TDLS) direct link or a peer-to-peer (P2P) link.

5. The non-AP STA of claim 1, wherein the processor is further configured to allocate another portion of the TXOP to another STA.

6. The non-AP STA of claim 1, wherein the STA is a controller of a peer-to-peer (P2P) group.

7. The non-AP STA of claim 1, wherein the processor is further configured to:
receive a response to the notification from the STA;
receive a frame during the portion of the TXOP from the STA; and
transmit an acknowledgement to the STA in response to the frame.

8. A first access point (AP) in a wireless network, the first AP comprising:
a memory;
a processor coupled to the memory, the processor configured to:
obtain a transmission opportunity (TXOP) for transmission of a frame on a link;
allocate a portion of the TXOP to a second AP; and
transmit a notification to the second AP indicating allocation of the portion of the TXOP to the second AP.

9. The first AP of claim 8, wherein the processor is further configured to allocate another portion of the TXOP to a non-AP station (STA).

10. The first AP of claim 8, wherein the notification is a trigger frame.

11. A first station (STA) in a wireless network, the first STA comprising:
a memory;
a processor coupled to the memory, the processor configured to:
receive an allocation of a first portion of a transmission opportunity (TXOP) from a second STA, wherein the TXOP is obtained by the second STA for transmission of a frame on a link;
allocate a second portion of the TXOP to a third STA, wherein the second portion is part or all of the first portion of the TXOP; and
transmit a notification to the third STA indicating the allocation of the second portion of the TXOP to the third STA.

12. The first STA of claim 11, wherein the processor is further configured to transmit frames to a fourth STA that is associated with the first STA through a remaining portion of the TXOP.

13. The first STA of claim 11, wherein the first STA is an access point (AP) or non-AP STA.

14. The first STA of claim 11, wherein the second STA is an access point (AP) or a non-AP STA.

15. The first STA of claim 11, wherein the first STA and the third STA are in a peer-to-peer (P2P) group.

16. The first STA of claim 15, wherein the first STA is a controller of the P2P group.

17. The first STA of claim 15, wherein the fourth STA is outside of the P2P group.

18. The first STA of claim 11, wherein the notification is a trigger frame.

19. The first STA of claim 11, wherein the processor is further configured to:
receive a response to the notification from the third STA;
receive a frame during the second portion of the TXOP from the third STA; and
transmit an acknowledgement to the third STA in response to the frame.

20. The first STA of claim 11, wherein the first STA and the third STA are connected over a Tunneled Direct Link Setup (TDLS) direct link or a peer-to-peer (P2P) link.
